(19) United States
(12) Patent Application Publication
(10) Pub. No.: US 2026/0002816 A1
(43) Pub. Date: Jan. 1, 2026

(54) SPECTROMETER CALIBRATION SOLUTION, CALIBRATION STANDARD, AND METHOD OF CALIBRATION

(71) Applicant: SPEX CertiPrep, Metuchen, NJ (US)

(72) Inventors: Alan H. KATZ, Lawrenceville, NJ (US); Louis WHALEY, Sayreville, NJ (US)

(21) Appl. No.: 19/319,114

(22) Filed: Sep. 4, 2025

Related U.S. Application Data
(63) Continuation of application No. PCT/US2024/019366, filed on Mar. 11, 2024.
(60) Provisional application No. 63/489,544, filed on Mar. 10, 2023.

(51) Int. Cl. G01J 3/02

(52) U.S. Cl. CPC G01J 3/0297

(57) ABSTRACT

Aspects are provided for a UV-Vis calibration solution, composed of a lanthanide and an ionic liquid. In particular, the UV-Vis calibration solution may contain 4 to 12% by weight of Holmium (III), dissolved in an aqueous chloride solution. The disclosure also includes a calibration standard created from this calibrated solution, by placing the solution in a cuvette and capping it. The disclosure additionally includes a method of using the calibration standard to obtain a UV-Vis spectrum in the wavelength range of about 250 nm to 700 nm.

### CROSS-REFERENCE TO RELATED APPLICATIONS

This application claims priority to U.S. Provisional Application No. 63/489,544 titled “SPECTROMETER CALIBRATION SOLUTION, CALIBRATION STANDARD, AND METHOD OF CALIBRATION,” filed Mar. 10, 2023, which is assigned to the assignee hereof, and incorporated herein by reference in its entirety.

### INTRODUCTION

Aspects of the present disclosure generally relate to spectrometer calibration, and more particularly to a spectrometer calibration solution, calibration standard, and method of calibration.

### BACKGROUND

A spectrometer is a scientific instrument used to separate and measure spectral components of a physical phenomenon. For example, a spectrometer may be used to determine chemical composition of a sample. Accuracy of a spectrometer may require calibration using a standard having known properties over a range of wavelengths.

Currently, a calibration standard for spectrometers uses either Holmium (III) or didydium(III) (a mixture of praseodymium and neodymium). Holmium (III) or didydium(III) standards are prepared typically in either aqueous perchloric acid solutions, or silicate glass.

Solutions of perchloric acid are corrosive and toxic, and render paper and wood explosive. Silicate glass is very thin and fragile. These properties make handling of conventional calibration standards difficult. Often, laboratories may specify that only experienced personnel are allowed to handle the calibration standards. Additionally, both types of standards are expensive. Accordingly, calibration of a spectrometer, although a relatively simple task, is often performed by senior scientists. Further, the dangers and costs make education and training with spectrometers difficult.

There remains an unmet need in the related art for calibration standards that do not suffer from these problems.

### SUMMARY

The following presents a simplified summary of one or more aspects of the present disclosure in order to provide a basic understanding of such aspects. This summary is not an extensive overview of all contemplated aspects, and is intended to neither identify key or critical elements of all aspects, nor delineate the scope of any or all aspects. Its purpose is to present some concepts of one or more aspects in a simplified form as a prelude to the more detailed description that is presented later.

In some aspects, the techniques described herein relate to a calibration solution including: an ionic liquid; and a lanthanide in the ionic liquid, the lanthanide including 4 to 12% by weight of the calibration solution.

In some aspects, the techniques described herein relate to a calibration solution, wherein the ionic liquid contains an aqueous halide.

In some aspects, the techniques described herein relate to a calibration solution, wherein the ionic liquid contains an aqueous chloride.

In some aspects, the techniques described herein relate to a calibration solution, wherein the lanthanide is holmium (III).

In some aspects, the techniques described herein relate to a calibration solution, wherein the calibration solution contains 12.0% HoCl3*7·7H2O.

In some aspects, the techniques described herein relate to a calibration solution, wherein the calibration solution contains 4.0% HoCl3*7·7H2O.

In some aspects, the techniques described herein relate to a calibration standard including: a cuvette; and a calibration solution in the cuvette, the calibration solution including: an ionic liquid; and a lanthanide in the ionic liquid, the lanthanide including 4 to 12% by weight of the calibration solution.

In some aspects, the techniques described herein relate to a calibration standard, wherein the ionic liquid contains aqueous halide.

In some aspects, the techniques described herein relate to a calibration standard, wherein the ionic liquid contains aqueous chloride.

In some aspects, the techniques described herein relate to a calibration standard, wherein the lanthanide is holmium (III).

In some aspects, the techniques described herein relate to a calibration standard, wherein the calibration solution contains 12.0% HoCl3*7·7H2O.

In some aspects, the techniques described herein relate to a calibration standard, wherein the calibration solution contains 4.0% HoCl3*7·7H2O.

In some aspects, the techniques described herein relate to a calibration standard, wherein cuvette contains 3.5 to 5 grams of the calibration solution.

In some aspects, the techniques described herein relate to a calibration standard, wherein the cuvette contains 3.75 mL of the calibration solution.

In some aspects, the techniques described herein relate to a method of calibrating a spectrometer, the method including: selecting a wavelength of light to calibrate; zeroing the spectrometer; inserting a calibration standard containing a calibration solution into the spectrometer, the calibration solution containing an ionic liquid and 4 to 12% by weight of a lanthanide; and causing the selected wavelength of light to pass through the calibration standard.

In some aspects, the techniques described herein relate to a method, wherein the ionic liquid contains an aqueous halide.

In some aspects, the techniques described herein relate to a method, wherein the ionic liquid contains an aqueous chloride.

In some aspects, the techniques described herein relate to a method, wherein the lanthanide is holmium (III).

In some aspects, the techniques described herein relate to a method, wherein the calibration solution contains 12.0% HoCl3*7·7H2O.

In some aspects, the techniques described herein relate to a method, wherein the calibration solution contains 4.0% HoCl3*7·7H2O.

In some aspects, the techniques described herein relate to a method, further including verifying a quantitation of H2O in the calibration solution.

In some aspects, the techniques described herein relate to a method, wherein verifying the quantitation of H2O in the calibration solution includes: weighing a sample of the calibration solution in a container; adding a drying agent to the calibration solution in a ratio to the weight of the sample; obtaining a total mass of the calibration solution, the drying agent, and the container; cyclically heating and cooling the calibration solution to a constant weight of the lanthanide; determining a lost mass as a weight of a drying agent hydrate; and calculating an original ratio of lanthanide to H2O in the calibration solution as a ratio of the constant weight of the lanthanide to the weight of the drying agent hydrate.

### BRIEF DESCRIPTION OF THE DRAWINGS

FIG. 1 is an example of a calibration standard including a lanthanide dissolved in an ionic liquid, according to an aspect of the disclosure.

FIG. 2 is an example of a set of calibration standards, according to an aspect of the disclosure.

FIG. 3 is an example of a UV-Vis spectrum of a Holmium perchlorate calibration standard.

FIG. 4 is an example of a UV-Vis spectrum of a Holmium glass calibration standard.

FIG. 5 is an example of a UV-Vis spectrum of an example Holmium aqueous chloride calibration standard, according to an aspect of the disclosure.

FIG. 6 is a zoomed-out view of the UV-Vis spectrum of the Holmium aqueous chloride calibration standard, given in FIG. 5.

FIG. 7 is a flowchart of an example method of calibrating a spectrometer, according to an aspect of the disclosure.

FIG. 8 is a flowchart of an example method of verifying a quantitation of water in a calibration solution, according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Standards using perchloric acid or silicate glass must be handled with significant care. Standards using perchloric acid are corrosive, toxic, and potentially explosive; and standards using silicate glass are very thin and fragile.

The present disclosure pertains to calibration standards and methods of creating calibration standards using lanthanides and room-temperature ionic liquids (RTILs) in which the lanthanides are dissolved. In an aspect, the disclosure provides for an example calibration standard including a Holmium (III) aqueous solution, dissolved in an ionic liquid.

The disclosed calibration standards do not have the hazardous properties of perchloric acid. Additionally, the calibration standard may be produced at a lower cost than calibration standards with perchloric acid or silicate glass.

Lanthanides have not been conventionally dissolved in RTILs. Rather, commercial versions of RTILs have focused on ore extraction, through the addition of additives such as phosphine oxides. For example, electronic metals e.g., Fe(II), Fe(III), Ni(II), Co(III), Cu (I), Cu(II), Au (I), Au(III) may be extracted using ionic liquids. Accordingly, commercial versions of an RTIL would not be suited for UV-Vis Spectroscopy.

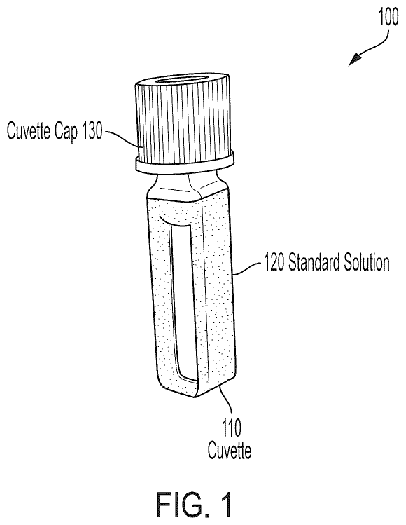

FIG. 1 is an example of a calibration standard 100 including a lanthanide dissolved in an ionic liquid.

In calibration standard 100, cuvette 110 provides a receptacle for standard solution 120. Standard solution 120 is comprised of an aqueous solution of a lanthanide and an ionic liquid. Cuvette 110 is sealed by cuvette cap 130, which provides an air-tight seal for easy transfer.

In an embodiment of calibration standard 100, the lanthanide in standard solution 120 is Holmium (III), and the ionic liquid is an aqueous halide, such as aqueous chloride. For example, the aqueous chloride [C₆H₁)₃P(C₁₄H₂₉)]⁺ may have a molecular weight of 519.3 grams/mol at a purity of 93-95%, a melting point of −50° C. and a safe operating temperature up to 140° C. In some implementations, the lanthanide may be selected from the group consisting of: praseodymium (Pr), neodymium (Nd), samarium (Sm), europium (Eu), terbium (Tb), dysprosium (Dy), holmium (Ho), erbium (Er), and thulium (Tm).

In an aspect, various ionic liquids and solutions may not be suitable for UV-Vis Spectroscopy standards. For example alkali metals and alkaline earths may result in precipitate forming. Hazardous or toxic metals may not be suitable. For example, Hg (I), Hg(II), Pb(II), and Pb (IV) may pose risks. Trivalent main-group metals e.g., Al(III), Ga(III), In(III), may react with water to make the mixture opaque with oxides. Rare-earth metal ions lacking partly-filled f-orbitals (none with full or completely empty f-orbitals), e.g., Ce (IV), Y(III), La(III), Lu(III), and Sc(III) which is sometimes included as a “rare earth” metal ion may not be suitable due to the properties of its salts and oxides.

In a preferred embodiment of calibration standard 100, the concentration of Holmium (III) is between about 4 to 12%. For instance, a maximum dissolvable concentration of Holmium (III) in aqueous chloride may be approximately 14%.

A higher concentration of Holmium (III) lowers the viscosity of standard solution 120. This, in turn, increases the probability of air bubbles forming within calibration standard 100. As a result, the effectiveness of calibration standard 100 may decrease above a certain threshold value where air bubbles that interfere with the absorption form, which has been shown to be about 12%. There must also be a minimum concentration of Holmium (III) in calibration standard 100 to obtain a useful UV-Vis spectrum. This minimum concentration is around 4%.

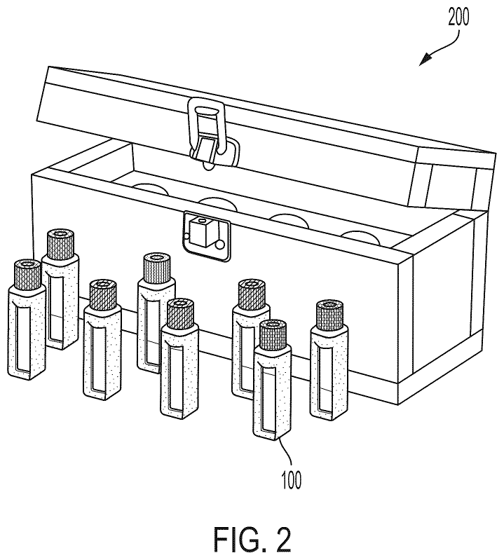

FIG. 2 is an example of a set of calibration standards. In calibration standard kit 200, several commercial calibration standards 100 are provided. The calibration standards 100 may include different standard solutions. For example, the calibration standards 100 may include different concentrations of the lanthanide. The caps of the calibration standards 100 may be color coded to indicate the contents. In some implementations, the commercial calibration standards 100 may include standard solutions with different dissolved lanthanides or different ionic solutions. Each calibration standard may be associated with known peaks and absorption patterns under UV-Vis Spectroscopy. For example, the known peaks and absorption patterns may be provided as a graph or table of key values.

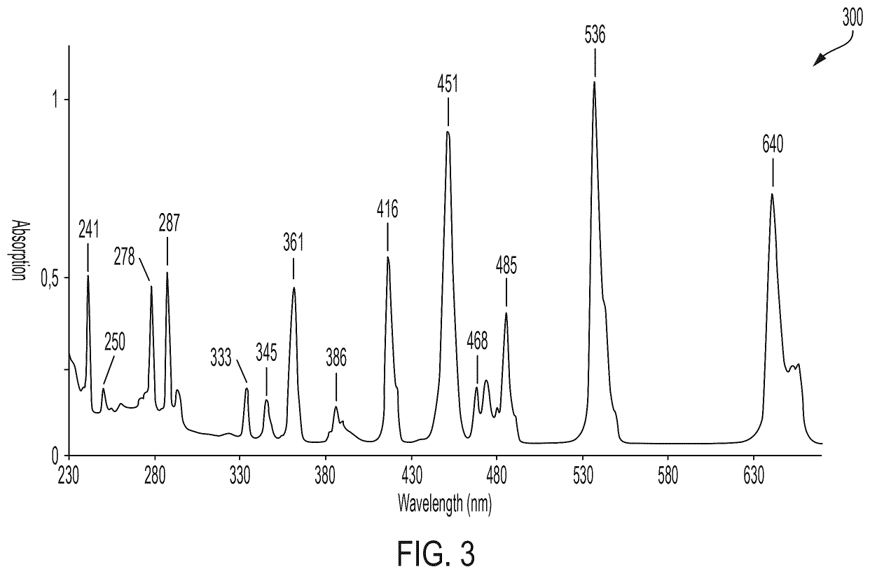

FIG. 3 is an example of a UV-Vis spectrum pattern 300 of a Holmium perchlorate calibration standard. In UV-Vis spectrum pattern 300, the standard peaks and absorption patterns of a Holmium perchlorate calibration standard are given. As indicated by the spectrum pattern 300, this calibration standard provides useful information within the wavelength range of about 230 nm to over 700 nm. In particular, the spectrum pattern 300 includes multiple peaks that can be compared across different spectrometers including calibrated and uncalibrated spectrometers. Further, a spectrometer may be calibrated until the spectrum pattern output for a calibration standard matches the known spectrum pattern 300 for the calibration standard.

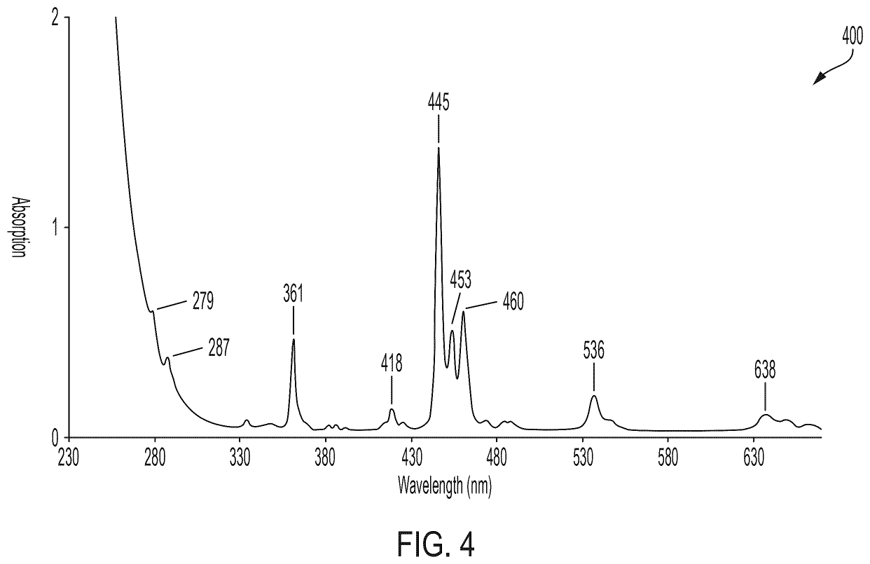

FIG. 4 is an example of a UV-Vis spectrum pattern 400 of a Holmium glass calibration standard. In UV-Vis spectrum pattern 400, the standard peaks and absorption patterns of a Holmium glass standard are given. As indicated by the spectrum pattern 400, this calibration standard provides useful information within the wavelength range of about 230 nm to 700 nm. That is, similar to spectrum pattern 300, the spectrum pattern 400 includes peaks at various wavelengths within the useful range.

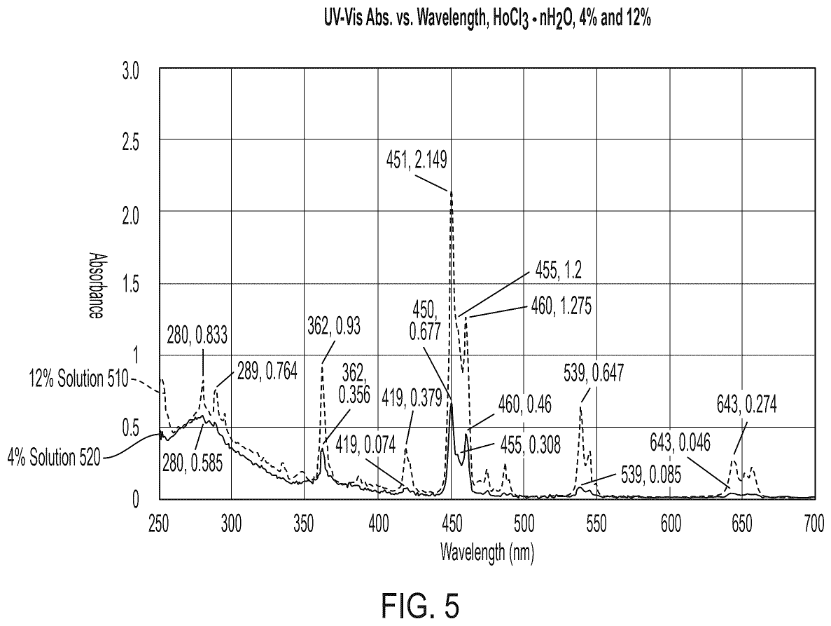

FIG. 5 is an example of a UV-Vis spectrum of an example Holmium aqueous chloride calibration standard, according to an aspect of the present disclosure. In UV-Vis spectrum 500, the standard peaks and absorption patterns of a Holmium chloride standard, according to an embodiment of the present disclosure, are given. UV-Vis spectrum 500 gives spectrum pattern 510 for the 12% solution of Holmium (III) and gives spectrum pattern 520 for the 4% solution of Holmium (III). Both the spectrum pattern 510 and the spectrum pattern 520 are similar to the spectrum pattern 400. That is, the peaks in the spectrum pattern 510 and the spectrum pattern 520 occur at approximately the same wavelengths and at approximately the same absorption levels.

As indicated in FIG. 5, the peaks for the spectrum pattern 510 are more pronounced than the peaks for the spectrum pattern 520. As noted above, an increased concentration of lanthanide may lower the viscosity of standard solution 120 and may increase the probability of air bubbles forming. In an aspect, there may be a tradeoff between the benefits of increased absorbance from higher concentrations of lanthanide (e.g., more pronounced peaks), and the likelihood of air bubbles forming. In some implementations, the concentration of lanthanide may be a highest concentration where the viscosity remains above a threshold that prevents air bubbles from forming.

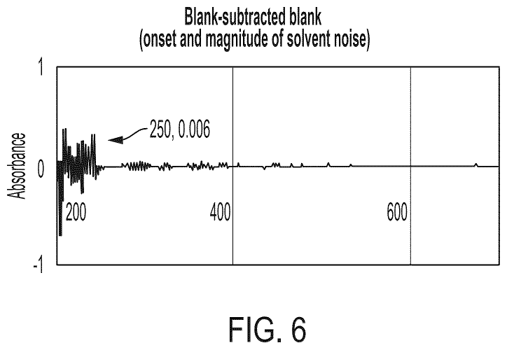

FIG. 6 is zoomed-out view of the UV-Vis spectrum of the Holmium aqueous chloride calibration standard given in FIG. 5 covering a larger range of wavelengths. As indicated by FIG. 6, the UV-vis spectrum pattern for Holmium chloride below 250 nm of wavelength is too noisy and unpredictable to be useful for a calibration standard. As a result, calibration standard 100, prepared with Holmium chloride provides useful information within the wavelength range of about 250 nm to 700 nm, which is almost equivalent to Holmium perchlorate and Holmium glass standards.

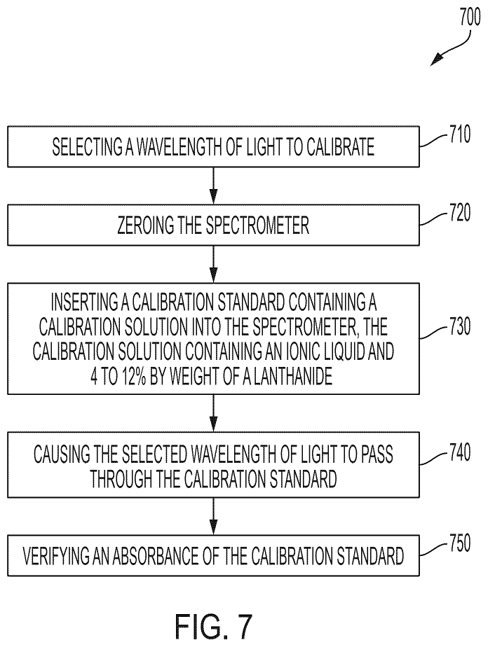

FIG. 7 is a flow diagram showing an example method 700 of calibrating a spectrometer. The method 700 may be performed on a spectrometer using the calibration standard 100.

In block 710, the method 700 may include selecting a wavelength of light to calibrate. This wavelength may be selected based on the useful range of the calibration standard 100 (e.g., 250 nm to 700 nm). In some implementations, the selected wavelength may be a wavelength corresponding to a known absorbance value from the spectrum pattern 500 of the calibration standard. For instance, the selected value may correspond to one of the peaks in the spectrum pattern 500.

In block 720, the method 700 may include zeroing the spectrometer, to ensure that the UV-Vis spectrum produced is as accurate as possible. In some implementations, zeroing the spectrometer may utilize a blank calibration standard without the lanthanide. That is, the blank calibration standard may include only the ionic liquid. Zeroing the spectrometer may account for any absorbance of the cuvette and ionic liquid such that only the absorbance of the lanthanide is measured.

In block 730, the method 700 may include inserting a calibration standard 100 containing a calibration solution 110 into the spectrometer, the calibration solution containing an ionic liquid and 4 to 12% by weight of a lanthanide. The calibration standard 100 is sized to fit the spectrometer, so the insertion should be seamless.

In block 740, the method 700 may include causing the selected wavelength of light to pass through the calibration standard 100. The spectrometer will measure the absorbance of the calibration standard 100 at the selected wavelength and output the measurement on a display.

In block 750, the method 700 may include a final step of verifying an absorbance of the calibration standard 100. The measurement from the spectrometer may be compared with a published value in the spectrum pattern 500 or a table of values for the calibration standard 500. The spectrometer may be considered correctly calibrated when the measured absorbance is within a specified tolerance of the published value. A measured absorbance outside of the specified tolerance may indicate a need for maintenance or service of the spectrometer. The spectrometer may be calibrated at multiple selected wavelengths within the range for the calibration standard 100.

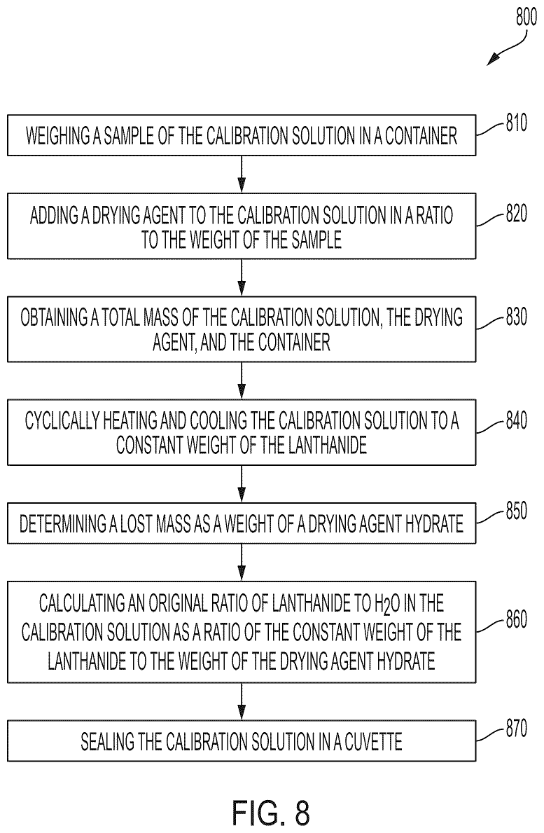

FIG. 8 is a flow diagram showing an example method 800 of manufacture of a calibration standard including verifying the quantitation of H₂O in the calibration solution.

In block 810, the method 800 may include weighing a sample of the calibration solution 120 in a container. The calibration solution may be weighed on a standard laboratory scale.

In block 820, the method 800 may include adding a drying agent to the calibration solution 120 in a ratio to the weight of the sample. For example, the drying agent may be triphosgene CAS 32315-10-9, which may be added in a ratio of 0.550 mg triphosgene (m.p. 80° C.) per 2 grams of calibration standard. Other example drying agents include thionyl chloride and phosphoryl chloride.

In block 830, the method 800 may include obtaining a total mass of the calibration solution, the drying agent, and the container. This may be done by weighing the calibration solution, drying agent and container on the same scale used in block 810.

In block 840, the method 800 may include cyclically heating and cooling the calibration solution to a constant weight of the lanthanide.

In block 850, the method 800 may include determining a lost mass as a weight of drying agent hydrate. The mass obtained in block 840 is subtracted from the mass obtained in block 830 to obtain this number.

In block 860, the method 800 may include calculating an original ratio of lanthanide to H₂O in the calibration solution as a ratio of the constant weight of the lanthanide to the weight of the drying agent hydrate. This number may be used to inform how the UV-Vis spectrum produced by the calibration standard is interpreted. For example, the quantitation of H₂O in the calibration solution may affect the maximum concentration of lanthanide in the calibration solution 110.

In block 870, the method 800 may include sealing the calibration solution in a cuvette. For example, the calibration solution may be poured into the cuvette and sealed with a cap.

In an aspect, the “drying agent hydrate” concept is a fiction that enables one to calculate the lost moles of water due to the dehydrating agent converting them to gas (hydrogen chloride gas and carbon dioxide gas). The drying agent hydrate compensates for the conversion of some of the dehydrating agent to an intermediate that remains in the standard (in the case of triphosgene, some diphosgene remains behind; in the case of thionyl chloride, some chlorosulfite salts might remain; in the case of phosphoryl chloride, POCl3, some pyrophosphoryl chloride might remain, etc.). The moles of hydrate that formed is related directly by a simple proportion to the moles of water per moles of lanthanide, giving the level of hydration. For example, for a drying agent that can react with and remove 3 water molecules the drying agent trihydrate is calculated. For triphosgene with formula C3Cl6O3 the corresponding hydrate formula is C3Cl6O3+3*H2O=C3H6Cl6O6, which is equivalent to 3*CO2+6*HCl.

This written description uses examples to disclose aspects of the present disclosure, including the preferred embodiments, and also to enable any person skilled in the art to practice the aspects thereof, including making and using any devices or systems and performing any incorporated methods. The patentable scope of these aspects is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A calibration solution comprising:
an ionic liquid; and
a lanthanide in the ionic liquid, the lanthanide comprising 4 to 12% by weight of the calibration solution.

2. The calibration solution of claim 1, wherein the ionic liquid contains an aqueous halide.

3. The calibration solution of claim 2, wherein the ionic liquid contains an aqueous chloride.

4. The calibration solution of claim 1, wherein the lanthanide is holmium (III).

5. The calibration solution of claim 4, wherein the calibration solution contains 12.0% HoCl3*7·7H₂O.

6. The calibration solution of claim 4, wherein the calibration solution contains 4.0% HoCl3*7·7H₂O.

7. The calibration solution of claim 4, wherein the lanthanide is selected from the group consisting of: praseodymium (Pr), neodymium (Nd), samarium (Sm), europium (Eu), terbium (Tb), dysprosium (Dy), holmium (Ho), erbium (Er), and thulium (Tm).

8. A calibration standard comprising:
a cuvette; and
a calibration solution in the cuvette, the calibration solution comprising:
an ionic liquid; and
a lanthanide in the ionic liquid, the lanthanide comprising 4 to 12% by weight of the calibration solution.

9. The calibration standard of claim 8, wherein the ionic liquid contains aqueous halide.

10. The calibration standard of claim 8, wherein the ionic liquid contains aqueous chloride.

11. The calibration standard of claim 8, wherein the lanthanide is holmium (III).

12. The calibration standard of claim 11, wherein the calibration solution contains 12.0% HoCl3*7·7H₂O.

13. The calibration standard of claim 11, wherein the calibration solution contains 4.0% HoCl3*7·7H₂O.

14. The calibration standard of claim 8, wherein cuvette contains 3.5 to 5 grams of the calibration solution.

15. The calibration standard of claim 8, wherein the cuvette contains 3.75 mL of the calibration solution.

16. The calibration standard of claim 8, wherein the lanthanide is selected from the group consisting of: praseodymium (Pr), neodymium (Nd), samarium (Sm), europium (Eu), terbium (Tb), dysprosium (Dy), holmium (Ho), erbium (Er), and thulium (Tm).

17. A method of calibrating a spectrometer, the method comprising:
selecting a wavelength of light to calibrate;
zeroing the spectrometer;
inserting a calibration standard containing a calibration solution into the spectrometer, the calibration solution containing an ionic liquid and 4 to 12% by weight of a lanthanide; and
causing the selected wavelength of light to pass through the calibration standard.

18. The method of claim 17, wherein the ionic liquid contains an aqueous halide.

19. The method of claim 17, wherein the ionic liquid contains an aqueous chloride.

20. The method of claim 17, wherein the lanthanide is holmium (III).

21. The method of claim 17, wherein the calibration solution contains 12.0% HoCl3*7·7H₂O.

22. The method of claim 17, wherein the calibration solution contains 4.0% HoCl3*7·7H₂O.

23. The method of claim 17, wherein the lanthanide is selected from the group consisting of: praseodymium (Pr), neodymium (Nd), samarium (Sm), europium (Eu), terbium (Tb), dysprosium (Dy), holmium (Ho), erbium (Er), and thulium (Tm).

24. A method of verifying a quantitation of H₂O in a calibration solution comprising a lanthanide, the method comprising:
weighing a sample of the calibration solution in a container;
adding a drying agent to the calibration solution in a ratio to a weight of the sample;
obtaining a total mass of the calibration solution, the drying agent, and the container;
cyclically heating and cooling the calibration solution to a constant weight of the lanthanide;
determining a lost mass as a weight of a drying agent hydrate; and
calculating an original ratio of lanthanide to H₂O in the calibration solution as a ratio of the constant weight of the lanthanide to the weight of the drying agent hydrate.
